(19) United States
(12) Patent Application Publication
(10) Pub. No.: US 2006/0208967 A1
(43) Pub. Date: Sep. 21, 2006

(54) Plasma display device

(75) Inventors: Makoto Onozawa, Yokohama (JP); Tomokatsu Kishi, Yamato (JP); Shinsuke Tanaka, Huchu (JP); Takashi Fujisaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/359,749

(22) Filed: Feb. 23, 2006

(30) Foreign Application Priority Data
Feb. 23, 2005 (JP) 2005-047780

(51) Int. Cl. G09G 3/28

(52) U.S. Cl. 345/60

(57) ABSTRACT

A plasma display device is provided, which includes a plasma display panel displaying an image, composed of plural display cells, and a reset circuit changing a reset power supply voltage to reset the display cell in accordance with an image to be displayed on the plasma display panel, and in which the rise change time of the reset power supply voltage is shorter than the fall change time thereof.

### CROSS-REFERENCE TO RELATED APPLICATIONS

This application is based upon and claims the benefit of priority from the prior Japanese Patent Application No. 2005-047780, filed on Feb. 23, 2005, the entire contents of which are incorporated herein by reference.

### BACKGROUND OF THE INVENTION

1. Field of the Invention The present invention relates to a plasma display device.

2. Description of the Related Art

In the following patent document 1, a plasma display device is described, in which, in accordance with the light emitting pixel ratio, a subfield reset voltage is lowered when displaying an image with a low ratio and the subfield reset voltage is raised when displaying an image with a high ratio.

(Patent Document 1) Japanese Patent Application Laid-open No. 2000-29431

The patent document 1, however, does not consider a control rate of a reset power supply voltage in accordance with the light emitting pixel image ratio. When a black display image changes to a white display image, the light emitting pixel ratio increases and it is necessary to raise the reset power supply voltage. If the rise rate of the reset power supply voltage is slow, there is the possibility that the drive voltage margin becomes short in a white display image etc. and flicker occurs on the display screen.

### SUMMARY OF THE INVENTION

It is an object of the present invention to provide a plasma display device capable of preventing flicker on a display screen which may occur when a reset power supply voltage changes.

According to an aspect of the present invention, a plasma display device is provided, which comprises a plasma display panel composed of plural display cells for displaying an image and a reset circuit for changing a reset power supply voltage to reset the display cell in accordance with an image to be displayed on the plasma display panel, and in which the rise change time of the reset power supply voltage is shorter than the fall change time thereof.

### BRIEF DESCRIPTION OF THE DRAWINGS

FIG. 1 is a diagram showing a configuration example of a plasma display device according to an embodiment of the present invention.

FIG. 2 is an exploded perspective view showing a structure example of a plasma display panel in the present embodiment.

FIG. 3 is a diagram showing a configuration example of one field of an image.

FIG. 4 is a circuit diagram showing a configuration example of an X drive circuit and a Y drive circuit according to the present embodiment.

FIG. 5 is a waveform diagram showing an operation example in one subfield of the drive circuit shown in FIG. 4.

FIG. 6 is a waveform diagram showing an operation example during a sustain period of the drive circuit shown in FIG. 4.

FIG. 7 is a circuit diagram showing a configuration example of a reset power supply circuit in FIG. 4.

FIG. 8 is a timing chart showing an operation example of the reset power supply circuit in FIG. 7.

### DETAILED DESCRIPTION OF THE PREFERRED EMBODIMENTS

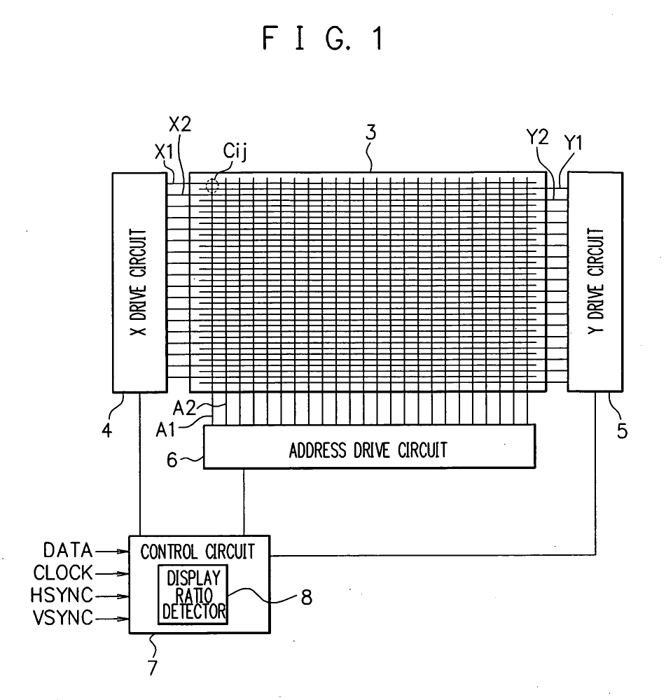

FIG. 1 is a diagram showing a configuration example of a plasma display device according to an embodiment of the present invention. A control circuit 7 has a display ratio detector 8, inputs therein an image data DATA, a clock signal CLOCK, a horizontal synchronization signal HSYNC, and a vertical synchronization signal VSYNC, and controls an X drive circuit 4, a Y drive circuit 5, and an address drive circuit 6.

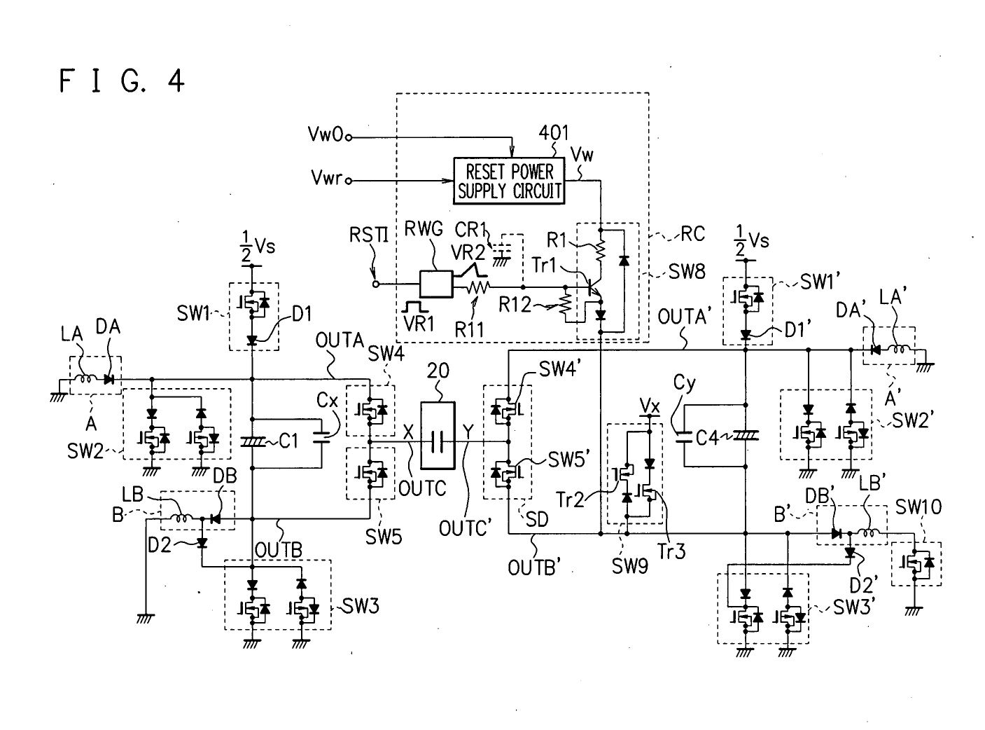

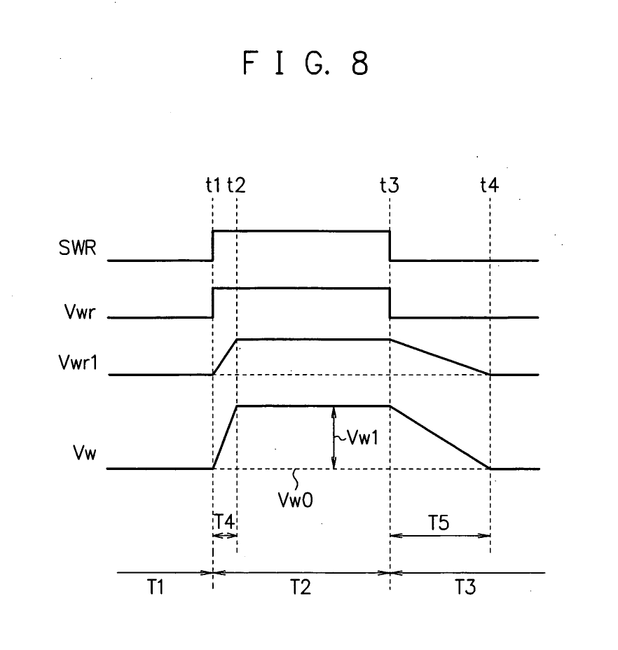

The display ratio detector 8 detects a display ratio of the entire surface of a plasma display panel 3 during one vertical synchronization period based on the image data DATA. The display ratio is determined in accordance with the number of light emitting pixels and the gradation level of light emission. When the entire surface of the panel 3 is displayed with the maximum gradation level value, the display ratio is 100%. When the entire surface of the panel 3 is displayed with one-tenth the maximum gradation level value, the display ratio is, for example, 10%. When 10% of the area of the panel 3 is displayed with the maximum gradation level value, the display ratio is also, for example, 10%. The Y drive circuit 5 has a reset circuit. The display ratio detector 8 outputs a detected display ratio signal Vwr (FIG. 4) to a reset circuit RC in the Y drive circuit 5. As shown in FIG. 8, the display ratio signal Vwr results in a low level in periods T1 and T3 during which the display ratio is lower than a predetermined value, and results in a high level in a period T2 during which the display ratio is higher than a predetermined value. The details will be explained later.

The X drive circuit 4 supplies a predetermined voltage to plural X electrodes Xl, X2, . . . . Hereinafter, each of the X electrodes X1, X2, . . . , is referred to as, or all of them are together referred to as the X electrode Xi, where i means a subscript. The Y drive circuit 5 supplies a predetermined voltage to plural Y electrodes Y1, Y2, . . . . Hereinafter, each of the Y electrodes Y1, Y2, . . . , is referred to as, or all of them are together referred to as the Y electrode Yi, where i means a subscript. The address drive circuit 6 supplies a predetermined, voltage to plural address electrodes A1, A2, . . . . Hereinafter, each of the address electrodes A1, A2, . . . , is referred to as, or all of them are together referred to as the address electrode Aj, where j means a subscript.

In the plasma display panel 3, the plural Y electrodes Yi and the plural X electrodes Xi form rows extending in parallel in the horizontal direction and the address electrode Aj forms a column extending in the vertical direction. The Y electrode Yi and the X electrode Xi are arranged by turns in the vertical direction. The Y electrode Yi and the address electrode Aj form an i row x j column two-dimensional matrix. A display cell Cij is formed of the crossing of the Y electrode Yi and the address electrode Aj and the adjoining X electrode Xi corresponding thereto. The display cell Cij corresponds to a pixel. The plasma display panel 3 is composed of the plural display cells Cij and is capable of displaying a two-dimensional image. The display cell Cij is a capacitive load including the X electrode Xi and the Y electrode Yi and a dielectric therebetween.

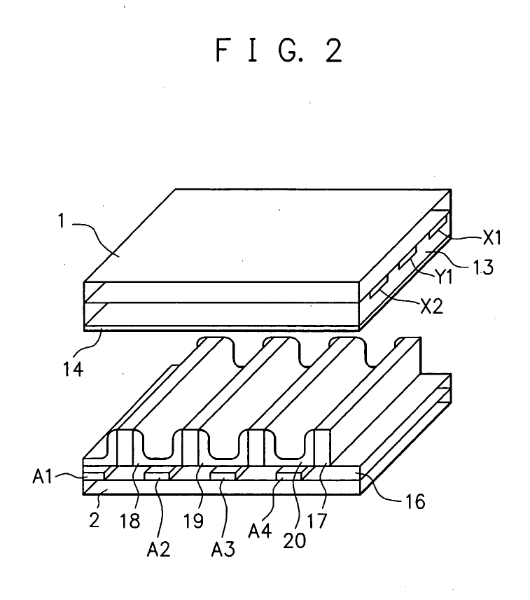

FIG. 2 is an exploded perspective view showing a structure example of the plasma display panel 3 in the present embodiment. The X electrode Xi and the Y electrode Yi are formed on a front glass substrate 1. Further, a dielectric layer 13 for insulating a discharge space is coated thereupon. Furthermore, a MgO (magnesium oxide) protective layer 14 is coated thereupon. On the other hand, the address electrode Aj is formed on a backside glass substrate 2 arranged in opposition to the front glass substrate 1. A dielectric layer 16 is coated thereupon. Further, phosphors 18 to 20 are coated thereupon. To the inner surface of partition wall (ribs) 17, the red, blue, and green phosphors 18 to 20 are applied in a stripe-shaped arrangement for each color. By a discharge between the X electrode Xi and the Y electrode Yi, the phosphors 18 to 20 are excited to emit light in each color. Into the discharge space between the front glass substrate 1 and the backside glass substrate 2, Ne+Xe Penning gas etc. is sealed.

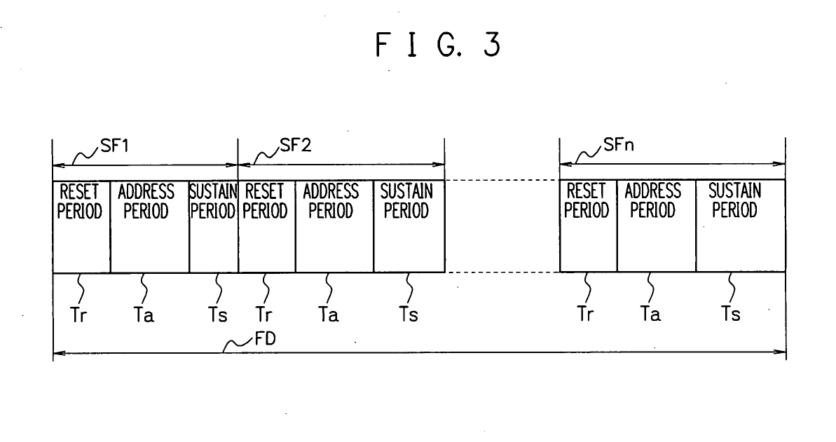

FIG. 3 is a diagram showing a configuration example of one field FD of an image. An image is formed of, for example, 60 fields/second. The one field FD is formed of a first subfield SF1, a second subfield SF2, . . . , and an n-th subfield SFn. For example, this n is 10, corresponding to the number of gradation level bits. Hereinafter, each of the subfields SF1, SF2, . . . , is referred to as, or all of them are together referred to as the subfield SF. An average subfield time corresponds to 600 subfields/second.

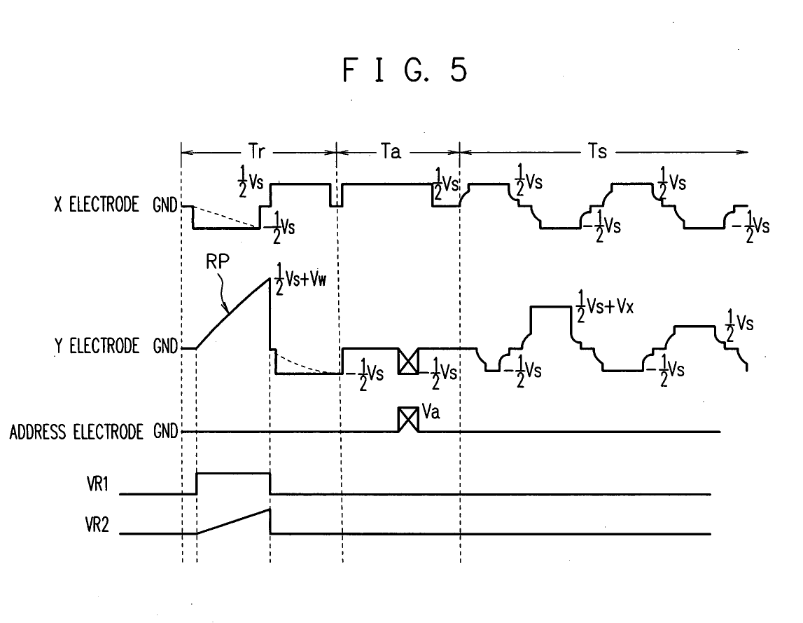

Each subfield SF is composed of a reset period Tr, an address period Ta, and a sustain (sustain discharge) period Ts. In the reset period Tr, initialization of the display cell Cij is performed. A reset power supply voltage for the initialization is controlled in accordance with a display ratio. In the address period Ta, it is possible to select to cause each display cell Cij to or not to emit light by an address discharge between the address electrode Aj and the Y electrode Yi. Specifically, by applying a scan pulse sequentially to the Y electrodes Y1, Y2, Y3, Y4, . . . ,and applying an address pulse to the address electrode Aj in accordance with the scan pulse, it is possible to select to cause a desired display cell Cij to emit light. In the sustain period Ts, a sustain discharge is caused to occur for light emission between the X electrode Xi and the Y electrode Yi in the selected display cell Cij. In each subfield SF, the number of times of weighted light emission (the length of the sustain period Ts) according to the sustain pulse between the X electrode Xi and the Y electrode Yi is different. Due to this, the gradation level value can be determined and a graded display can be produced. Detailed explanation of the subfield SF will be given later with reference to FIG. 5.

In an odd field, a sustain discharge is caused to occur between the electrodes X1 and Y1, between the electrodes X2 and Y2, between the electrodes X3 and Y3, etc., and in an even field, a sustain discharge is caused to occur between the electrodes Y1 and X2, between the electrodes Y2 and X3, between the electrodes Y3 and X4, etc. In other words, the Y electrode constitutes one display cell between itself and adjoining one side of the X electrode and constitutes another display cell between itself and adjoining the other side of the X electrode.

FIG. 4 is a circuit diagram showing a configuration example of the X drive circuit 4 and the Y drive circuit 5 in the present embodiment. A capacitive load 20 corresponds to the display cell Cij composed of the X electrode X, the Y electrode Y, and the dielectric therebetween. The X drive circuit 4 is a circuit on the left-hand side of the capacitive load 20 and applies a predetermined voltage to the X electrode X. The Y drive circuit 5 is a circuit on the right-hand side of the capacitive load 20 and applies a predetermined voltage to the Y electrode Y.

Hereinafter, a MOS field-effect transistor is simply referred to as a transistor. Every n channel transistor has a parasitic diode, and the anode of the parasitic diode is connected to the source and the cathode of the parasitic diode is connected to the drain. Every p channel transistor also has a parasitic diode, and the anode of the parasitic diode is connected to the drain and the cathode of the parasitic diode is connected to the source.

First, the X drive circuit (sustain circuit) will be explained. A switch SW4 is composed of an n channel transistor and connected between signal lines OUTA and OUTC. The signal line OUTC is connected to the X electrode X. The signal line OUTA can be connected to the X electrode X of the capacitive load 20. A switch SW5 is composed of an n channel transistor and connected between a signal line OUTB and the signal line OUTC. The signal line OUTB can also be connected to the X electrode X of the capacitive load 20. Capacitors C1 and Cx are connected between the signal lines OUTA and OUTB.

A switch SW1 is a series connection of an n channel transistor and a diode D1 and connected between the signal line OUTA and a potential +Vs/2 (a first potential). The anode of the diode D1 is connected to the potential +Vs/2 side and the cathode thereof is connected to the signal line OUTA side.

A switch SW2 is formed in such a way that a series connection of an n channel transistor and a diode is connected in parallel with a series connection of a p channel transistor and a diode, and the switch SW2 is connected between the signal line OUTA and the ground potential. In the n channel transistor, the anode of the diode is connected to the signal line OUTA and the cathode is connected to the drain of the n channel transistor, and in the p channel transistor, the anode of the diode is connected to the drain of the p channel transistor and the cathode is connected to the signal line OUTA. The switch SW2 is a bidirectional switch.

A coil circuit A has a configuration in which a coil LA and a diode DA are connected in series and is connected between the signal line OUTA and the ground potential. The cathode of the diode DA is connected to the signal line OUTA. The coil LA is connected between the anode of the diode DA and the ground potential.

A switch SW3 is formed in such a way that a series connection of an n channel transistor and a diode is connected in parallel with a series connection of a p channel transistor and a diode, and the switch SW3 is connected between the signal line OUTB and the ground potential. In the n channel transistor, the anode of the diode is connected to the signal line OUTB and the cathode is connected to the drain of the n channel transistor, and in the p channel transistor, the anode of the diode is connected to the drain of the p channel transistor and the cathode is connected to the signal line OUTB. The switch SW3 is a bidirectional switch.

A coil circuit B has a configuration in which a coil LB and a diode DB are connected in series and is connected between the signal line OUTB and the ground potential. The anode of the diode DB is connected to the signal line OUTB. The coil LB is connected between the cathode of the diode DB and the ground potential. The anode of a diode D2 is connected to the cathode of the diode DB and the cathode is connected to the signal line OUTB.

Next, the Y drive circuit will be explained. The Y drive circuit has a reset circuit and a sustain circuit. The reset circuit is a circuit for resetting a display cell in the reset period Tr in FIG. 5. The sustain circuit is a circuit for supplying the display cell with a sustain pulse for display in the sustain period Ts in FIG. 5.

The sustain circuit of the Y drive circuit has the same configuration as that of the X drive circuit. A switch SW4′ is configured by an n channel transistor and connected between signal lines OUTA′ and OUTC′. The signal line OUTC′ is connected to the Y electrode Y. The signal line OUTA′ can be connected to the Y electrode Y of the capacitive load 20. A switch SW5′ is configured by an n channel transistor and connected between a signal line OUTB′ and the signal line OUTC′. The signal line OUTB′ can also be connected to the Y electrode Y of the capacitive load 20. Capacitors C4 and Cy are connected between the signal lines OUTA′ and OUTB′.

The switches SW4′ and SW5′ constitute a scan driver SD. The scan drive SD performs switching operation in order to output a scan pulse for the Y electrode Y in the address period Ta in FIG. 5.

A switch SW1′ is a series connection of an n channel transistor and a diode D1′ and connected between the signal line OUTA′ and the potential +Vs/2. The anode of the diode D1′ is connected to the potential +Vs/2 side and the cathode is connected to the signal line OUTA′ side.

A switch SW2′ is formed in such a way that a series connection of an n channel transistor and a diode is connected in parallel with a series connection of a p channel transistor and a diode, and the switch SW2′ is connected between the signal line OUTA′ and the ground potential. In the n channel transistor, the anode of the diode is connected to the signal line OUTA′ and the cathode is connected to the drain of the n channel transistor, and in the p channel transistor, the anode of the diode is connected to the drain of the p channel transistor and the cathode is connected to the signal line OUTA′. The switch SW2′ is a bidirectional switch.

A coil circuit A′ has a configuration in which a coil LA′ and a diode DA′ are connected in series and is connected between the signal line OUTA′ and the ground potential. The cathode of the diode DA′ is connected to the signal line OUTA′. The coil LA′ is connected between the anode of the diode DA′ and the ground potential.

A switch SW3′ is formed in such a way that a series connection of an n channel transistor and a diode is connected in parallel with a series connection of a p channel transistor and a diode, and the switch SW3′ is connected between the signal line OUTB′ and the ground potential. In the n channel transistor, the anode of the diode is connected to the signal line OUTB′ and the cathode is connected to the drain of the n channel transistor, and in the p channel transistor, the anode of the diode is connected to the drain of the p channel transistor and the cathode is connected to the signal line OUTB′. The switch SW3′ is a bidirectional switch.

A coil circuit B′ has a configuration in which a coil LB′ and a diode DB′ are connected in series. The coil circuit B′ and a switch 10 connected in series are connected between the signal line OUTB′ and the ground potential. The switch 10 is configured by an n channel transistor. The anode of the diode DB′ is connected to the signal line OUTB′. The anode of a diode D2′ is connected to the cathode of the diode DB′ and the cathode is connected to the drain of the n channel transistor of the switch SW3′.

A switch SW9 includes n channel transistors Tr2 and Tr3, is connected between the signal line OUTB′ and a potential Vx, and is capable of generating the voltage of the Y electrode Y in the sustain period Ts in FIG. 5.

Next, the reset circuit RC in the Y drive circuit will be explained. A reset power supply circuit 401 inputs therein a direct current reset power supply voltage Vw0 and varies to output a reset power supply voltage Vw in accordance with the display ratio signal Vwr. The display ratio signal Vwr results in the low level in the periods T1 and T3 during which the display ratio is lower than a predetermined value, and results in the high level in the period T2 during which the display ratio is higher than a predetermined value, as shown in FIG. 8. The reset power supply voltage Vw results in a low voltage Vw when the display ratio signal Vwr is at the low level and results in a high voltage Vw0+Vw1 when the display ratio signal Vwr is at the high level. However, a reset power supply voltage rise change time T4 is shorter than a reset power supply voltage fall change time T5.

The input terminal of a reset waveform generation circuit RWG is connected to a reset signal input terminal RSTI and the output terminal is connected to the base of an npn bipolar transistor Tr1 via a resistor R11. The collector of the npn bipolar transistor Tr1 is connected to the reset power supply voltage Vw via a resistor R1 and the emitter is connected to the signal line OUTB′ via a diode. A diode is connected between the signal line OUTB′ and the reset power supply voltage Vw. A resistor R12 is connected between the base and emitter of the npn bipolar transistor Tr1. A capacitor CR1 is a stray capacitor between the base of the npn bipolar transistor Tr1 and the ground potential.

The reset waveform generation circuit RWG generates to output a ramp wave (obtuse wave) VR2, the signal level (for example, voltage, current, etc.) of which changes with lapse of time, from a reset signal VR1, which is a rectangular wave inputted from the reset signal input terminal RSTI. Additionally, the change rate of the signal level of the ramp wave VR2 may be constant regardless of lapse of time or may be caused to change with lapse of time (for example, the change rate is gradually reduced with lapse of time).

A switch SW8 includes the resistor R1 and the npn bipolar transistor Tr1, is connected between the signal line OUTB′ and the reset power supply voltage Vw, and is capable of generating a reset pulse RP of the Y electrode Y in the reset period Tr in FIG. 5.

The switch 10 is a switch for preventing voltages (Vs/2+Vw) and (Vs/2+Vx) to be applied to the signal line OUTB′ in the reset period Tr, the address period Ta, etc., in FIG. 5 from passing through to the ground potential without action.

FIG. 5 is a waveform diagram showing an operation example in one subfield SF in the drive circuit shown in FIG. 4, also showing waveform examples of the voltages of the X electrode, the Y electrode, and the address electrode. One subfield is divided into the reset period Tr composed of an entire surface write period and an entire surface erase period, the address period Ta, and the sustain period Ts.

First, the reset period Tr will be explained. The voltage to be applied to the X electrode X is lowered from the ground potential to a voltage −Vs/2.

On the other hand, when the activated reset signal VR1 is inputted to the Y electrode Y via the reset signal input terminal RSTI, the reset waveform generation circuit RWG outputs the ramp wave VR2. Then, the npn bipolar transistor Tr1 gradually turns on. Due to this, the voltage to be applied to the Y electrode Y gradually rises with lapse of time and finally, a voltage, which is the sum of the reset power supply voltage Vw and the voltage Vs/2, is applied to the Y electrode Y. The reset pulse RP to be applied to the Y electrode is a saw-tooth-shaped reset pulse (including a saw wave and an obtuse wave) The reset circuit RC generates a saw-tooth-shaped reset pulse based on the reset power supply voltage Vw and supplies it to the capacitive load (display cell) 20.

In this way, the potential difference between the X electrode X and the Y electrode Y results in (Vs+Vw) and a discharge is caused to occur in all of the display cells of all of the display lines regardless of the previous display state and wall charges are formed (entire surface write).

Next, after returning the voltages of the X electrode and the Y electrode Y to the ground potential, the voltage applied to the X electrode X is raised from the ground potential to the voltage Vs/2 and the voltage applied to the Y electrode Y is lowered to the voltage −Vs/2. Due to this, the voltage of the wall charge itself exceeds the discharge start voltage in all of the display cells, causing a discharge to start, and thus the accumulated wall charges are erased (entire surface erase).

Next, the address period Ta will be explained. In order to turn on/off each display cell in accordance with image data, address selection is performed in a line-sequential manner. At this time, the voltage Vs/2 is applied to the X electrode X. When a voltage is applied to the Y electrode Y corresponding to a certain display line, the voltage −Vs/2 is applied to the Y electrode Y selected in a line-sequential manner and the ground potential is applied to the Y electrode Y not selected.

At this time, to the address electrode Aj among the respective address electrodes A1 to Am, corresponding to the display cell in which a sustain discharge is caused to occur, that is, the display cell to be lit, an address pulse having a voltage Va is selectively applied. As a result, a discharge is caused to occur between the address electrode Aj of the display cell to be lit and the Y electrode Y selected in a line sequential manner and with this as a priming, this discharge immediately transitions to a discharge between the X electrode and the Y electrode Y. Due to this, an amount of wall charges enough to enable a next sustain discharge is accumulated on the MgO protective film surface on the X electrode X and the Y electrode Y of the selected display cell.

Next, the sustain period Ts will be explained. The voltage of the X electrode X gradually rises due to the action of the coil circuit A. Then, in the vicinity of the peak voltage +Vs/2 of the rise, the voltage of the X electrode X is clamped to Vs/2.

Next, the voltage of the Y electrode Y gradually falls. At this time, part of charges is recovered by the coil circuit B′. Then, in the vicinity of the peak voltage −Vs/2 of the fall, the voltage of the Y electrode Y is clamped to −Vs/2.

Similarly, when the voltages to be applied to the X electrode X and the Y electrode Y are changed from the voltage −Vs/2 to the ground potential, the voltage to be applied is caused to gradually rise. To the Y electrode Y, the voltage (Vs/2+Vx) is applied only when the first high voltage is applied. Additionally, the voltage Vx is a voltage to be added to generate a voltage necessary for a sustain discharge by adding it to the voltage of wall charges generated during the address period Ta.

When the voltages to be applied to the X electrode X and the Y electrode Y are changed from the voltage Vs/2 to the ground potential, the voltage to be applied is caused to gradually fall and part of charges accumulated in the display cell is recovered by the coil circuits B and B′.

In this manner, during the sustain period Ts, a sustain discharge is caused to occur by alternately applying the voltages (+Vs/2, −Vs/2) with different polarities to the X electrode X and the Y electrode Y of each display line, and an image corresponding to one subfield is displayed. In other words, discharge light emission is caused to occur each time the potential difference between the X electrode X and the Y electrode Y approaches Vs, and the light emission is thus repeated.

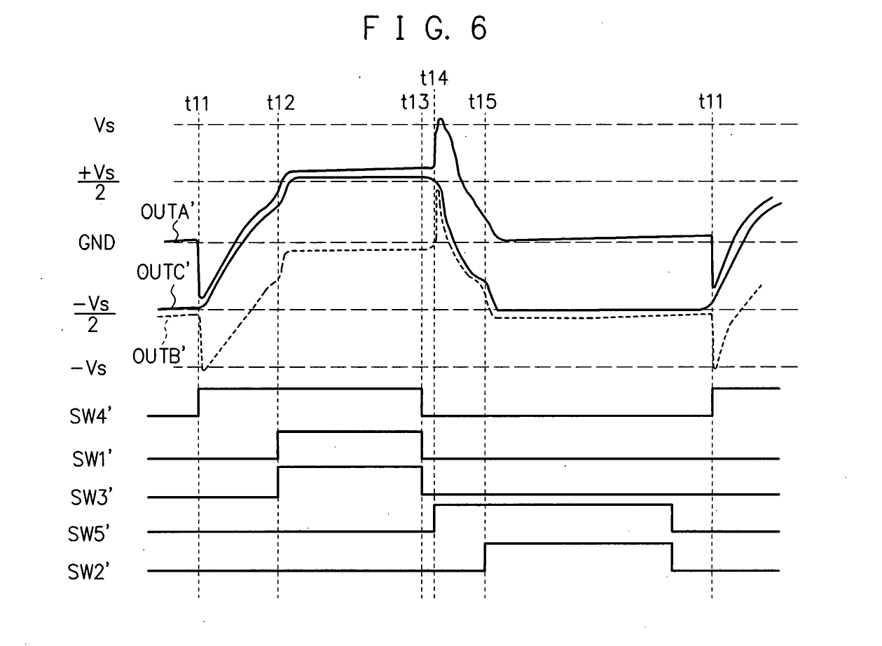

FIG. 6 is a waveform diagram showing an operation example during the sustain period Ts of the drive circuit shown in FIG. 4, also showing the drive waveform of the Y electrode Y. The voltage waveforms of the signal line OUTA′, the signal line OUTB′, and the signal line OUTC′ are shown together. Here, in order to make these voltage waveforms easier-to-see, the voltage waveform of the signal line OUTA′ is slightly lifted and the voltage waveform of the signal line OUTB′ is slightly lowered with respect to the voltage waveform of the signal line OUTC′ in the figure.

Before time t11, the switches SW1′, SW2′, SW3′, SW4′, and SW5′ are off. The signal line OUTC′ is separated from the signal lines OUTA′ and OUTB′. The signal line OUTA′ is at the ground potential and the signal lines OUTB′ and OUTC′ are at the voltage −Vs/2. A capacitor C4 is charged with the voltage Vs/2.

At time t11, the switch SW4′ is turned on. The voltage −Vs/2 of the signal line OUTC′ accumulated in the capacitive load 20 is transferred to the signal line OUTA′ via the switch SW4′. Due to this, the voltage of the signal line OUTA′ becomes −Vs/2 and the voltage is applied to one terminal of the capacitor C4. With this, the potential at the other terminal of the capacitor C4 changes to −Vs and the voltage of the signal line OUTB′ also becomes −Vs.

Then, immediately after time t11, LC resonance occurs between the coil LA′ and the capacitive load 20 via the switch SW4′, thereby charges are supplied to the capacitive load 20 from the ground potential via the coil LA′ and the switch SW4′. Due to this, the potential of the signal lines OUTA′ and OUTC′ rises from −Vs/2 to as high as about +Vs/2 through the ground potential. According to such a flow of charges, the voltage of the signal line OUTC′ to be applied to the Y electrode Y gradually rises as shown from time t11 to time t12.

Next, at time t12, in the vicinity of the peak voltage that occurs at the time of resonance (in more detail, before the voltage +Vs/2 is reached), by turning on the switches SW1′ and SW3′, the voltage of the signal line OUTC′ to be applied to the Y electrode Y is clamped to +Vs/2.

Next, at time t13, the switches SW1′, SW3′, and SW4′ are turned off. The signal line OUTC′ is separated from the signal line OUTA′.

Next, at time t14, the switch SW5′ is turned on. Due to this, the voltage Vs/2 of the signal line OUTC′ accumulated in the capacitive load 20 is applied to the signal line OUTB′ via the switch SW5′ and the voltage of the signal line OUTB′ becomes Vs/2. Following this, the voltage of the signal line OUTA′ rises to Vs.

Then, immediately after time t14, LC resonance occurs between the coil LB′ and the capacitive load 20 via the switch SW5′, thereby the capacitive load 20 discharges the charges to the ground potential via the coil LB′ and the switch SW5′. Due to this, the potential of the signal lines OUTB′ and OUTC′ falls from +Vs/2 to as low as about −Vs/2 through the ground potential. According to such a flow of charges, the voltage of the signal line OUTC′ to be applied to the Y electrode Y gradually falls as shown from time t14 to time t15.

Next, at time t15, in the vicinity of the peak voltage generated at the time of resonance (in more detail, before the voltage −Vs/2 is reached), the switch SW2′ is turned on. Due to this, the voltage of the output line OUTC′ to be applied to the Y electrode Y is clamped to −Vs/2.

After that, the X drive circuit performs the same operation as that of the Y drive circuit described above. In other words, the signal lines OUTA, OUTB, and OUTC have the same voltage waveforms as those of the signal lines OUTA′, OUTB′, and OUTC′. The sustain circuit supplies sustain pulses for display, the positive and negative polarities of which are alternately turned over, to the capacitive load (display cell) 20. Then, the Y drive circuit and the X drive circuit alternately generate sustain pulses, thereby sustain pulses having opposite phases to each other are generated and a sustain discharge is caused to occur.

The signal lines OUTC and OUTC′ do not have the clamp (sustain) period at the ground level. In other words, in the drive circuit according to the present embodiment, when the sustain operation is performed with the same period, it is possible to lengthen the time during which the voltage +Vs/2 or the voltage −Vs/2, which is the top width and the bottom width of a sustain pulse, is sustained. Due to this, it is possible to ensure more certainly the time for wall charges to move between the X electrode and the Y electrode during the sustain period Ts. Further, it is possible to cause a sustain discharge to occur more stably and therefore, the operating margin can be enlarged and the luminance of the plasma display panel can be improved.

Incidentally, both the coil circuit A (A′) and the coil circuit B (B′) are not necessarily needed but one of them will do.

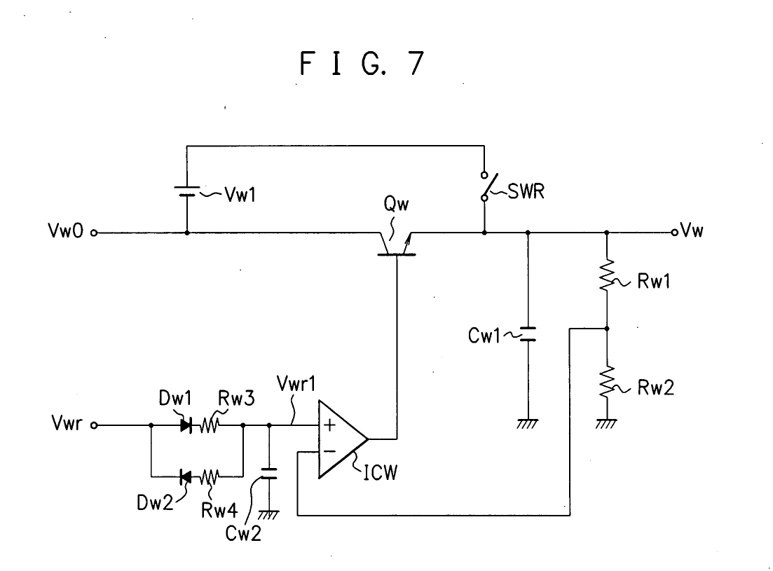

FIG. 7 is a circuit diagram showing a configuration example of the reset power supply circuit 401 in FIG. 4. An auxiliary direct current power supply Vw1 can be configured using a transformer, or a charge pump, or the like, and the cathode is connected to the terminal of the reset power source supply voltage Vw0 and the anode is connected to the terminal of the reset power supply voltage Vw via a switch SWR. A capacitor Cw1 is connected between the terminal of the reset power supply voltage Vw and the ground potential. Resistors Rw1 and Rw2 connected in series are connected between terminal of the reset power supply voltage Vw and the ground potential. The anode of a diode Dw1 is connected to the terminal of the display ratio signal Vwr and the cathode is connected to the positive input terminal of a comparator ICW. The cathode of a diode Dw2 is connected to the terminal of the display ratio signal Vwr and the anode is connected to the positive input terminal of the comparator ICW via a resistor Rw4. A capacitor Cw2 is connected between the positive input terminal of the comparator ICW and the ground potential. The negative input terminal of the comparator ICW is connected to the mutual connection point of the resistors Rw1 and Rw2 and the output terminal is connected to the base of an npn bipolar transistor Qw. The collector of the npn bipolar transistor Qw is connected to the terminal of the reset power supply voltage Vw0 and the emitter is connected to the terminal of the reset power supply voltage Vw.

FIG. 8 is a timing chart showing an operation example of the reset power supply circuit in FIG. 7. The horizontal axis represents time and the vertical axis represents voltage. The period T1 is the period before time t1, the period T2 is the period between time t1 to time t3, and the period T3 is the period after time t3. The periods T1 and T3 are periods during which the display ratio is lower than a predetermined value and the period T2 is a period during which the display ratio is higher than a predetermined value. The display ratio signal Vwr results in the low level during the periods T1 and T3 because the display ratio is low, and in the high level during the period T2 because the display ratio is high. The voltage Vwr1 is a voltage at the positive input terminal of the comparator ICW.

Before time t1, the switch SWR is off. The comparator ICW compares the voltage Vwr1 with the resistor-divided voltage of the resistors Rw1 and Rw2 and outputs a voltage of the comparison result. The bipolar transistor Qw controls a current that flows between the collector and emitter in accordance with the voltage of the comparison result. As a result, the reset power supply voltage Vw maintains the same voltage as the reset power supply voltage Vw0.

Next, at time t1, the switch SWR turns on and the display ratio signal Vwr changes from the low level to the high level. Consequently, a current flows from the terminal of the display ratio signal Vwr to the capacitor Cw2 via the diode Dw1 and the resistor Rw3. The voltage Vwr1 rises from the low level to the high level at a rate in accordance with the CR time constant of the resistor Rw3 and the capacitor Cw2. Since the resistor Rw3 is small in resistance, the rise rate is fast. Similarly, the reset power supply voltage Vw also rises.

Next, at time t2, the voltage Vwr1 reaches the high level and the reset power supply voltage Vw results in Vw0+Vw1.

Next, at time t3, the switch SWR turns off and the display ratio signal Vwr results in the low level. Consequently, a current flows from the capacitor Cw2 to the terminal of the display ratio signal Vwr via the diode Dw2 and the resistor Rw4. The voltage Vwr1 falls from the high level to the low level at a rate in accordance with the CR time constant of the resistor Rw4 and the capacitor Cw2. Since the resistor Rw4 is large in resistance, the fall rate is slow. Similarly, the reset power supply voltage Vw also falls.

Next, at time t4, the voltage Vw1 reaches the low level and the reset power supply voltage Vw results in Vw0. After this, this state is maintained.

The rise change time T4 of the reset power supply voltage Vw is the period from time t1 to time t2 and the fall change time T5 is the period from time t3 to time t4. Since the resistor Rw3 is smaller than the resistor Rw4 in resistance, the rise change time T4 is shorter than the fall change time T5.

It is necessary for the reset power supply voltage Vw to be set to a proper value in order to reset a display cell. However, the proper reset power supply voltage Vw changes in accordance with the display ratio. In the periods T1 and T3 during which the display ratio is low, a proper value is the low voltage Vw0 for the reset power supply voltage Vw and in the period T2 during which the display ratio is high, a proper value is the high voltage Vw0+Vw1 for the reset power supply voltage Vw.

For example, when a black display image changes to a white display image, the display ratio increases and it is necessary to raise the reset power supply voltage Vw. In the case where the rise rate of the reset power supply voltage Vw is slow, the drive voltage margin becomes short and flicker may occur on the display screen.

According to the present embodiment, the rise change time T4 of the reset power supply voltage Vw is made shorter than the fall change time T5, therefore, it is possible to prevent flicker on the display surface when a black display image changes to a white display image.

If the reset power supply voltage Vw is raised when the display ratio is low, background light emission occurs because of an excessive discharge by a reset pulse and the contrast is reduced. According to the present embodiment, it is possible to set the rest power supply voltage Vw on a display with a normal gradation level, that is, the display ratio is not high, to the low voltage Vw0 by changing the reset power supply voltage Vw in accordance with the display ratio, and therefore, it is possible to achieve the improvement of the contrast.

As described above, according to the present embodiment, the reset power supply voltage Vw resetting a display cell in accordance with an image (display ratio) to be displayed on a plasma display panel is changed. The rise change time T4 of the reset power supply voltage Vw is shorter than the fall change time T5.

As shown in FIG. 3, an image is composed of plural fields FD and each field FD is composed of plural subfields SF weighted for producing a graded display. It is preferable for the rise change time T4 of the reset power supply voltage Vw to be within an average subfield time.

The time of one field corresponds to 60 fields/second. One field is composed of, for example, 10 subfields. The average subfield time corresponds to 600/second. Therefore, it is preferable for the rise change time T4 of the reset power supply voltage to be within 1.6 ms. In contrast to this, the fall change time T5 of the reset power supply voltage is, for example, one to two seconds. Further, it is also preferable for the change range Vw1 of the reset power supply voltage Vw to be 20 V or higher.

As described above, by making the rise change time T4 of the reset power supply voltage Vw shorter than the fall change time T5, it is possible to speedily cope with a white display image that requires a high voltage. As a specific configuration, if the auxiliary power supply circuit Vw1 and the like is added to the reset power supply circuit 401, it is possible to generate a high reset power supply voltage Vw by speedily charging from the auxiliary power supply circuit Vw1 etc. for a white display image.

Additionally, the above embodiments merely show embodied examples when the present invention is performed and should not be interpreted as those to limit the technical scope of the present invention. In other words, the present invention can be performed in various ways without departing from the technical spirit and the main features.

Since the rise change time of the reset power supply voltage is made shorter than the fall change time, it is possible to prevent flicker on the display screen when a black display image changes to a white display image. Further, it is possible to reduce the reset power supply voltage on the screen with a normal gradation level by changing the reset power supply voltage in accordance with a display image to achieve the improvement of the contrast.

What is claimed is:

1. A plasma display device comprising:
a plasma display panel displaying an image, composed of plural display cells; and
a reset circuit changing a reset power supply voltage to reset said display cell in accordance with an image to be displayed on said plasma display panel, and
wherein a rise change time of said reset power supply voltage is shorter than a fall change time.

2. The plasma display device according to claim 1, wherein
said image is composed of plural fields, and each field is composed of plural subfields weighted to produce a graded display; and
said rise change time is within an average subfield time.

3. The plasma display device according to claim 1, wherein said rise change time is within 1.6 ms.

4. The plasma display device according to claim 1, wherein said reset circuit raises, when displaying an image with a high display ratio, said reset power supply voltage.

5. The plasma display device according to claim 1, wherein said reset circuit generates a saw-tooth-shaped reset pulse based on said reset power supply voltage and supplies the saw-tooth-shaped reset pulse to said display cell.

6. The plasma display device according to claim 1, wherein
said plasma display panel has plural first electrodes and plural second electrodes;
said first electrodes and said second electrodes are arranged in parallel by turns; and
said second electrode constitutes one display cell between itself and adjoining one side of said first electrode and constitutes another display cell between itself and adjoining the other side of said first electrode.

7. The plasma display device according to claim 1, further comprising a sustain circuit supplying sustain pulses for display with positive and negative polarities alternately turned over to said display cell.

8. The plasma display device according to claim 1, wherein
said display cell is a capacitive load;
a sustain circuit supplying sustain pulses for display is further provided at one end of said capacitive load; and
said sustain circuit comprises:
a first signal line connectable to one end of said capacitive load;
a second signal line connectable to one end of said capacitive load;
a first switch connected between said first signal line and a first potential;
a second switch connected between said first signal line and a second potential;
a capacitor connected between said first and second signal lines;
a third switch connected between said second signal line and said second potential; and
a coil circuit connected between at least one of said first and second signal lines and said second potential.

9. A plasma display device comprising:
a plasma display panel displaying an image, composed of plural display cells; and
a reset circuit changing a reset power supply voltage to reset said display cell in accordance with an image to be displayed on said plasma display panel, and
wherein said image is composed of plural fields, each of its field composed of plural subfields weighted to produce a graded display; and a rise change time of said reset power supply voltage is within an average subfield time.

10. The plasma display device according to claim 9, wherein said reset circuit raises, when displaying an image with a high display ratio, said reset power supply voltage.

11. The plasma display device according to claim 9, wherein said reset circuit generates a saw-tooth-shaped reset pulse based on said reset power supply voltage and supplies the saw-tooth-shaped reset pulse to said display cell.

12. The plasma display device according to claim 9, wherein
said plasma display panel has plural first electrodes and plural second electrodes;
said first electrodes and said second electrodes are arranged in parallel by turns; and
said second electrode constitutes one display cell between itself and adjoining one side of said first electrode and constitutes another display cell between itself and adjoining the other side of said first electrode.

13. The plasma display device according to claim 9, further comprising a sustain circuit supplying sustain pulses for display with positive and negative polarities alternately turned over to said display cell.

14. The plasma display device according to claim 9, wherein
said display cell is a capacitive load;
a sustain circuit supplying sustain pulses for display is further provided at one end of said capacitive load; and
said sustain circuit comprises:
a first signal line connectable to one end of said capacitive load;
a second signal line connectable to one end of said capacitive load;
a first switch connected between said first signal line and a first potential;
a second switch connected between said first signal line and a second potential;
a capacitor connected between said first and second signal lines;
a third switch connected between said second signal line and said second potential; and
a coil circuit connected between at least one of said first and second signal lines and said second potential.

15. A plasma display device comprising:
a plasma display panel displaying an image, composed of plural display cells; and
a reset circuit changing a reset power supply voltage to reset said display cell in accordance with an image to be displayed on said plasma display panel, and
wherein a rise change time of said reset power supply voltage is within 1.6 ms.

16. The plasma display device according to claim 15, wherein said reset circuit raises, when displaying an image with high display ratio, said reset power supply voltage.

17. The plasma display device according to claim 15, wherein said reset circuit generates a saw-tooth-shaped reset pulse based on said reset power supply voltage and supplies the saw-tooth-shaped reset pulse to said display cell.

18. The plasma display device according to claim 15, wherein
said plasma display panel has plural first electrodes and plural second electrodes;
said first electrodes and said second electrodes are arranged in parallel by turns; and
said second electrode constitutes one display cell between itself and adjoining one side of said first electrode and constitutes another display cell between itself and adjoining the other side of said first electrode.

19. The plasma display device according to claim 15, further comprising a sustain circuit supplying sustain pulses for display with positive and negative polarities alternately turned over to said display cell.

20. The plasma display device according to claim 15, wherein
said display cell is a capacitive load;
a sustain circuit supplying sustain pulses for display is further provided at one end of said capacitive load; and
said sustain circuit comprises:
a first signal line connectable to one end of said capacitive load;
a second signal line connectable to one end of said capacitive load;
a first switch connected between said first signal line and a first potential;
a second switch connected between said first signal line and a second potential;
a capacitor connected between said first and second signal lines;
a third switch connected between said second signal line and said second potential; and
a coil circuit connected between at least one of said first and second signal lines and said second potential.
